(19) United States
(12) Patent Application Publication
(10) Pub. No.: US 2009/0129455 A1
(43) Pub. Date: May 21, 2009

(54) APPARATUS FOR AND METHOD OF AUTOMATICALLY CONTROLLING SKEW BETWEEN TRANSMITTED DATA

(75) Inventors: Jong Ho Kim, Daejeon (KR); Jong-Yoon Shin, Daejeon (KR); Je Soo Ko, Daejeon (KR)

Correspondence Address: LAHIVE & COCKFIELD, LLP;FLOOR 30, SUITE 3000, ONE POST OFFICE SQUARE, BOSTON, MA, 02109, US

(73) Assignee: Electronics & Telecommunications Research Institute, Daejeon (KR)

(21) Appl. No.: 12/184,505

(22) Filed: Aug. 1, 2008

(30) Foreign Application Priority Data
Nov. 20, 2007 (KR) 10-2007-0118527

(51) Int. Cl. H04B 17/00

(52) U.S. Cl. 375/228

(57) ABSTRACT

Provided is an apparatus for and method of automatically controlling skew between transmitted data, which is caused when a common low-speed field-programmable gate array (FPGA) transmits signals having a transmission rate in the range of tens of Gbps to an optical transponder. The apparatus and method can transmit data with a transmission rate of several Gbps irrespective of the type of the FPGA.

### CROSS-REFERENCE TO RELATED PATENT APPLICATION

This application claims the benefit of Korean Patent Application No. 10-2007-0118527, filed on Nov. 20, 2007, in the Korean Intellectual Property Office, the disclosure of which is incorporated herein in its entirety by reference.

### BACKGROUND OF THE INVENTION

1. Field of the Invention

The present invention relates to an apparatus for and method of automatically controlling skew between transmitted data, and more particularly, to an apparatus for and method of controlling skew between transmitted data, in order to create an interface between a field-programmable gate array (FPGA) and a high-speed serializer.

The present invention relates to an apparatus for and method of controlling skew between transmitted data, which is caused when a conventional low-speed FPGA transmits signals at a speed of tens of Gbps to an optical transponder.

The present invention is derived from a research project supported by the Information Technology (IT) Research & Development (R&D) program of the Ministry of Information and Communication (MIC) and the Institute for Information Technology Advancement (IITA) [2006-S-060-02, Development of OTH-based 40G Multi-service Transmission Technology].

2. Description of the Related Art

Several years ago, it was almost impossible to use gigabit signals as input/output signals in field-programmable gate arrays (FPGAs).

However, with the recent technological developments, Gbps signals as input/output signals can now be used in FPGAs.

However, in order to freely use signals with a speed of several Gbps as input/output signals in FPGAs, gigabit transceivers provided by FPGA manufacturers are still required.

When being connected to a high-speed serializer, an FPGA processes signals with a speed of tens of Gbps according to Serdes Framer Interface Level-5 (SFI-5).

That is, in order to process signals according to the SFI-5 standard, the FPGA should be configured to include gigabit transceivers.

The FPGA compensates for skew between 16 several Gbps data signals, serializes the compensated 16 several Gbps data signals into tens of Gbps signals, and outputs the tens of Gbps signals.

The tens of Gbps signals output from the FPGA are input to the high-speed serializer.

Since the amount of skew between data signals which a conventional tens of Gbps high-speed serializer can allow is not large, data skew between the 16 several Gbps signals output from the FPGA should be as small as possible.

However, the gigabit transceivers included in the FPGA operate independently, the amount of skew between the 16 several Gbps data signals is very large.

Although the FPGA is capable of processing a plurality of several Gbps signals, when the amount of skew is large, it is difficult to create an interface between the FPGA and the high-speed serializer while meeting the requirement of the SFI-5 standard.

### SUMMARY OF THE INVENTION

The present invention provides an apparatus and method which enable a high-speed serializer included in an optical transponder to receive signals without errors by allowing a field-programmable gate array (FPGA) including gigabit transceivers to automatically compensate for skew between output signals.

According to an aspect of the present invention, there is provided an apparatus for automatically controlling skew between transmitted data, the apparatus comprising: a high-speed serializer serializing a plurality of low-speed parallel data signals into high-speed data signals, outputting the high-speed data signals, and generating an out of alignment (OOA) alarm signal when skew between the low-speed parallel data signals which exceeds an allowable limit is generated; a plurality of selectors including a skew-free signal that prevents the OOA alarm signal from being generated into signals other than at least one signal from among the low-speed parallel data signals; a plurality of delay units delaying and outputting in units of bits the at least one low-speed data signal into which the skew-free signal is not included; and a delay control unit controlling the selectors and the delay units on the basis of the OOA alarm signal of the high-speed serializer.

According to another aspect of the present invention, there is provided a method of automatically controlling skew between transmitted data, the method comprising: including a skew-free signal, which prevents an OOA alarm signal from being generated when skew between a plurality of low-speed parallel data signals which exceeds an allowable limit is generated, into signals other than a first low-speed parallel data signal from among the low-speed parallel data signals; delaying and outputting the first low-speed data signal in units of bits; obtaining an optimal delay that prevents the OOA alarm signal from being generated by changing the delay of the first low-speed data signal; repeating the including of the skew-free signal, the delaying and outputting of the first low-speed data signal, and the obtaining of the optimal delay on each of the other signals than the first low-speed parallel data signal from among the plurality of low-speed parallel data signals; and serializing a plurality of low-speed parallel data signals which are output each by the obtained optimal delay value and outputting the serialized low-speed parallel data signals as high-speed data signals.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram of a Serdes Framer Interface Level-5 (SFI-5) interface illustrating devices and signal lines formed therebetween;

FIG. 2 is a block diagram illustrating an SFI-5 transmitter in the SFI-5 interface of FIG. 1;

FIG. 3 is a block diagram illustrating an SFI-5 receiver in the SFI-5 interface of FIG. 1;

FIG. 4 illustrates the structure of a frame used in a deskew signal;

FIG. 5 illustrates a process of sampling 16 data signals;

FIG. 6 is a block diagram illustrating an apparatus that performs parallel signal processing using a conventional field-programmable gate array (FPGA) according to SFI-5;

FIG. 7 is a block diagram illustrating an apparatus for automatically controlling skew between transmitted data according to an embodiment of the present invention;

FIG. 8 is a block diagram of a delay of the apparatus of FIG. 7 according to an embodiment of the present invention;

FIG. 9 is a flowchart illustrating the operation of a delay control unit of the apparatus of FIG. 7 according to an embodiment of the present invention; and

FIG. 10 illustrates the operation of the delay control unit of FIG. 9 on a time axis according to an embodiment of the present invention.

### DETAILED DESCRIPTION OF THE INVENTION

The present invention will now be described more fully with reference to the accompanying drawings, in which exemplary embodiments of the invention are shown.

The optical internetworking forum (OIF) defines Serdes Framer Interface Level-5 (SFI-5) as a standard for transmitting tens of Gbps high-speed signals between devices.

According to the SFI-5 standard, one data signal with a transmission rate of tens of Gbps is divided into 16 data signals with a transmission rate of several Gbps and then these 16 data signals are transmitted.

Due to a physical path length difference, a delay between the 16 data signals is generated.

The delay between the 16 data signals is called skew. In order to eliminate the skew between the 16 data signals, a deskew signal is used.

The deskew signal has samples for the 16 data signals, and a receiving end compensates for the skew between the 16 signals by comparing patterns of the 16 data signals with the samples of the deskew signal and calculating the delay between the 16 signals.

An apparatus for automatically controlling skew generated when signals of several Gbps are transmitted between an FPGA and a high-speed serializer according to an embodiment of the present invention will be exemplarily explained.

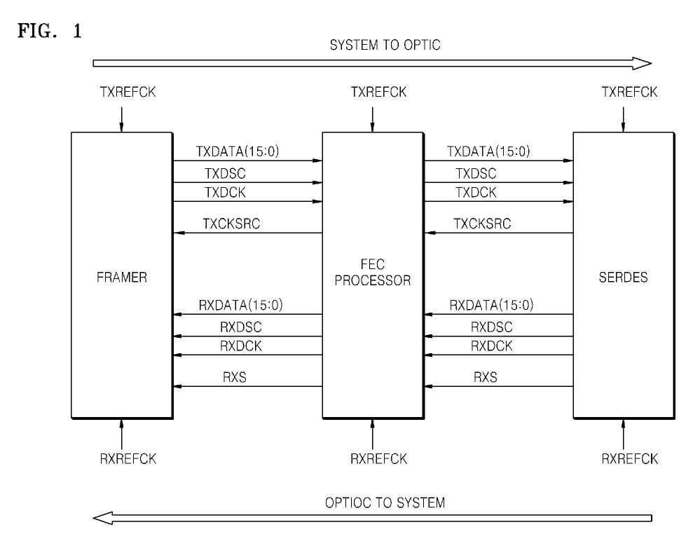

FIG. 1 is a block diagram of a conventional SFI-5 interface illustrating devices and signal lines formed therebetween.

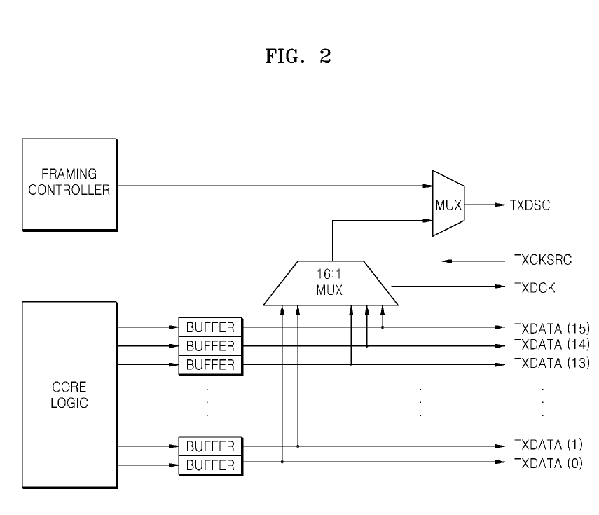

FIG. 2 is a block diagram illustrating an SFI-5 transmitter in the SFI-5 interface of FIG. 1.

Referring to FIG. 2, 16 signals TXDATA 0 through TXDATA 15 of several Gbps and a deskew signal TXDSC are simultaneously outputted.

The deskew signal TXDSC is transmitted after the 16 signals are sampled and a frame pattern is inserted.

Each of the data signals TXDATA 0 through TXDATA 15 has a transmission rate of several Gbps.

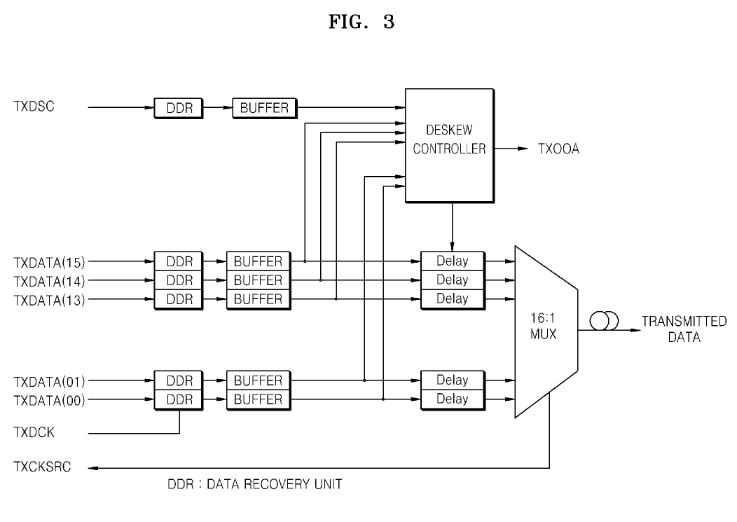

FIG. 3 is a block diagram illustrating an SFI-5 receiver in the SFI-5 interface of FIG. 1.

The receive interface receives the 16 data signals TXDATA 0 through TXDATA 15 and the deskew signal TXDSC, compares patterns thereof, and calculate the delay between the 16 data signals.

The receive interface adjusts the delays of the 16 signal delays on the basis of the calculated delay to generate skew-free signals, and serializes the skew-free signals into a 16:1 signal.

Each of the data signals has a transmission rate of several Gbps.

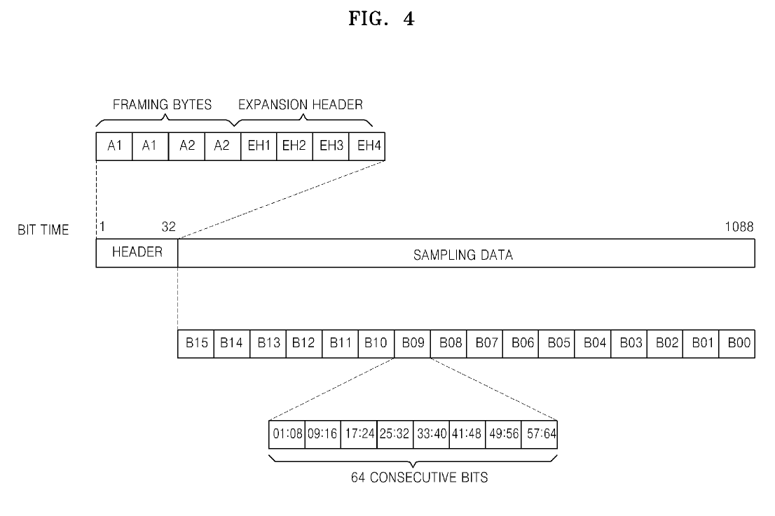

FIG. 4 illustrates the structure of a frame used in a deskew signal.

The frame of the deskew signal consists of framing bytes, expansion header bytes, and sampling data. The sampling data are multiplexed in turn.

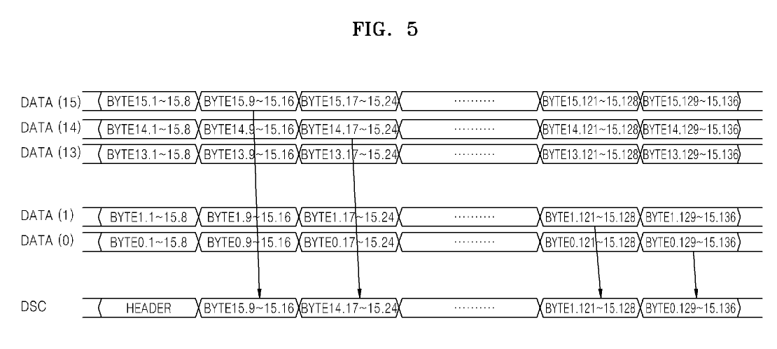

FIG. 5 illustrates a process for sampling 16 data signals DATA 0 through DATA 15 to generate a deskew signal DSC.

The 16 data signals are sampled in a byte-oriented frame.

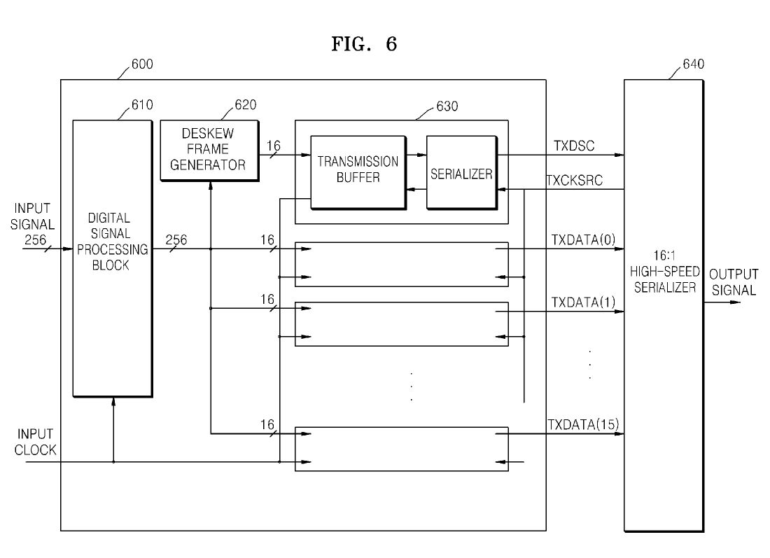

FIG. 6 is a block diagram illustrating an apparatus that performs parallel signal processing using a conventional field-programmable gate array according to SFI-5.

The apparatus includes an FPGA 600 and a 16:1 high-speed serializer 640 generating tens of Gbps signals.

Since the internal operating speed of the FPGA 600 does not reach several Gbps, the internal operating speed of the FPGA 600 is hundreds of Mbps.

The FPGA 600 includes a digital signal processing block 610, a deskew frame generator 620, and gigabit transceivers 630.

256 parallel signals are input to the FPGA 600, processed by the digital signal processing block 610, and input to the deskew frame generator 620.

The deskew frame generator 620 generates a deskew signal according to the SFI-5 standard.

The 256 parallel signals are provided in such a manner that 16 parallel signals are assigned to each of the gigabit transceivers 630.

Each of the gigabit transceiver 630 includes a transmission buffer and a serializer.

Each of the gigabit transceivers 630 serializes the 16 parallel signals and generates several Gbps signals.

The number of the gigabit transceivers 630, including the gigabit transceiver 630 for generating a deskew signal, is 17.

Since the 17 gigabit transceivers 630 in FIG. 6 operate independently, the 17 gigabit transceivers 630 read data from the transmission buffer or performed serialization at different times from one another.

Accordingly, much skew is generated between data TXDATA 0 through TXDATA 15 that are final output signals of the FPGA 600.

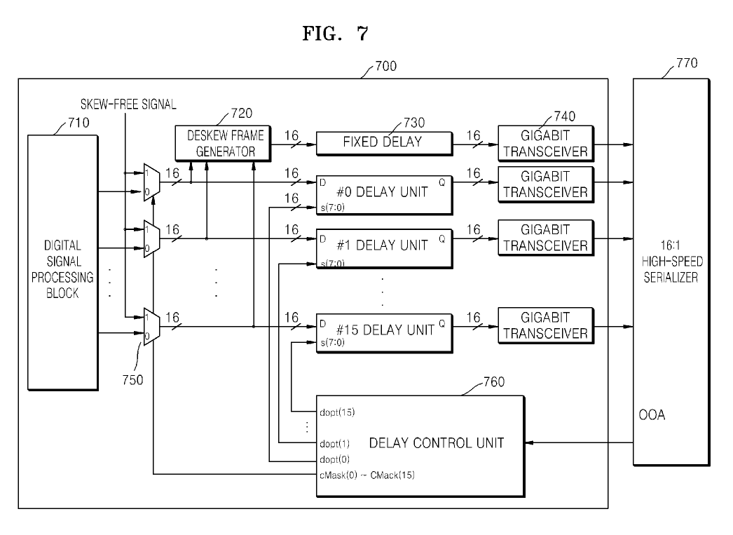

A configuration for solving this problem is shown in FIG. 7.

FIG. 7 is a block diagram of an apparatus for automatically controlling skew between transmitted data according to an embodiment of the present invention.

An FPGA 700 includes a digital signal processing block 710, a deskew frame generator 720, and gigabit transceivers 740, which are the same as those of FIG. 6, and further includes selectors 750 inserting a skew-free signal into output signals of the digital signal processing block 710, delay units 730 delaying 16 parallel signals that are to be input to the gigabit transceivers 740, and a delay control unit 760 receiving an out of alignment (OOA) signal from a tens of Gbps high-speed serializer 770 and controlling the delay units 730 and the selectors 750.

Each element will now be explained in further detail.

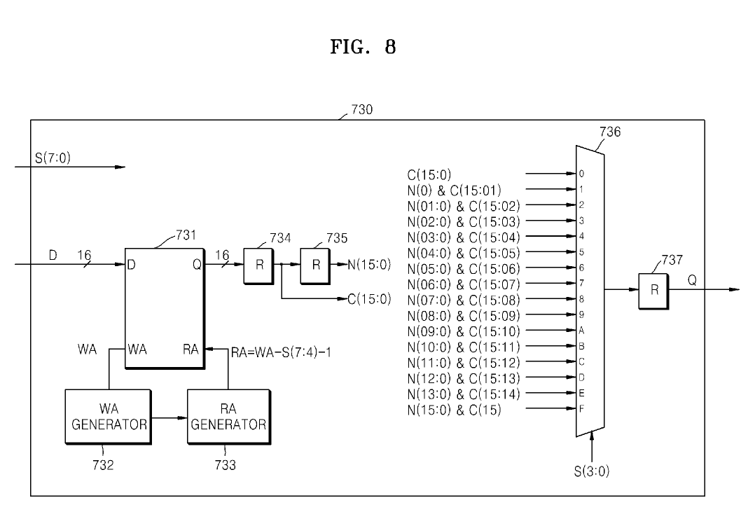

FIG. 8 is a block diagram of each of the delay units 730 of the apparatus of FIG. 7 according to an embodiment of the present invention.

In FIG. 8, the delay unit 730 receives 16 parallel signals with a speed of hundreds of Mbps as input signals.

The delay unit 730 receives a S(7:0) signal, which is a control signal for adjusting the delay, and delays and outputs the input signals.

The operation of the delay unit 730 will now be explained in detail.

A memory 731 which is 16 bits deep and 16 bits wide, a 4-bit write address (WA) generator 732, and a 4-bit read address (RA) generator 733 are used to delay the input signal in units of 16 bits.

The relationship between the RA generator 733 and the WA generator 732 of the delay 730 for delaying the input signals in units of 16 bits is as follows.

RA=WA−S(7:4)−1

When a difference between the RA generator 733 and the WA generator 732 is 1, there is a difference of one clock between the 16 parallel signals with a speed of hundreds of Mbps.

When the 16 parallel signals with a speed of hundreds of Mbps having a difference of one clock therebetween are serialized into several Gbps signals, the several Gbps signals are delayed by 16 clocks.

In order for the delay unit 730 to receive the 16 parallel signals with a speed of hundreds of Mbps and delay the several Gbps signals by one clock, connection shown in FIG. 8 needs to be done.

The 16 parallel signals of the memory 731 are retimed two times by D-flip-flops 734 and 735, and then are connected to a 16:1 selector 736.

Final signals output from the delay unit 730 are obtained by retiming signals output from the 16:1 selector 736 by a D-flipflop 737 again.

As a select signal Shift(3:0) of the 16:1 selector 736 is increased one by one, several Gbps signals are delayed by one clock.

A fixed delay unit 730 connected to an output of the deskew frame generator 720 from among the delay units 730 shown in FIG. 7 has a fixed delay that is different from those of data signals.

The #0 through #15 delay unit 730 except the fixed delay unit 730 respectively receive dopt signals, which are output signals of the delay control unit 760, through S(7:0) signals.

Each of the dopt signals is a 8-bit signal. The values of the dopt signals is changed according to an algorithm in the delay control unit 760.

The delay control unit 760 generates a cMask(15:0) signal that is a control signal for the selector 750 to insert a skew-free signal.

Outputs of the delay units 730 are respectively connected to gigabit transceivers 740 and then are serialized to output several Gbps signals.

The basic operation of the delay control unit 760 that is essential in the present invention will now be explained.

The delay control unit 760 inserts the skew-free signal into all data signals, transmits the data signals into which the skew-free signal is inserted, and checks whether an OOA state is normal in the 16:1 high-speed serializer 770.

Here, a skew-free signal is defined as follows.

A special signal with respect to which the 16:1 high-speed serializer 770 does not generate an OOA alarm irrespective of the delays of the data signals is referred to as a skew-free signal.

The 16:1 high-speed serializer 770 compares the deskew signal with each of the data signals and checks the delay for each of the data signals.

The 16:1 high-speed serializer 770 performs a process on the basis of the checked delays so that the 16 data signals can have the same delay. When the skew exceeds a predetermined limit, the same delay cannot be achieved and thus an OOA alarm is generated.

Even though the delay between a sample of the deskew signal and a data signal exceeds a predetermined limit, there is a signal that the 16:1 high-speed serializer 770 cannot detect.

For example, it is assumed that 16 bit signals input to the delay unit 730 have a fixed pattern 0xAAAA.

The 16:1 high-speed serializer serializes the input 16 bit signals into several Gbps signals.

Thus, the serialized signals have the value “ . . . 10101010 . . . ”. At this time, only 2 clocks in the several Gbps signals are detected as skew between the deskew signal and the data signal.

Since the 16:1 high-speed serializer 770 allows skew of about 5 to 6 clocks in the several Gbps signals, the 16:1 high-speed serializer 770 determines that this is a normal state and does not generate an OOA alarm irrespective of the delay of the data signal.

Such a special signal with respect to which the 16:1 high-speed serializer 770 does not generate an OOA alarm irrespective of the delay of a data signal is referred to as a skew-free signal.

An OOA alarm provided from the 16:1 high-speed serializers 770 is output as a sum of OOA alarms of 16 data signals. Only one data signal with normal data signal and the other data, that is, 15 data signals with a skew-free signal are applied such that it is known that the OOA alarm of the 16:1 high-speed serializer 770 is OOA state information on the signal to which the data signal with normal data signal is applied.

In this way, an OOA alarm provided from the 16:1 high-speed serializer 770 can be used as OOA state information on each of the 16 data signals.

By adjusting the delay of each of the 16 data signals using OOA state information of each data signal, the 16:1 high-speed serializer 770 can control skew between the data signals within a range where data can be normally received.

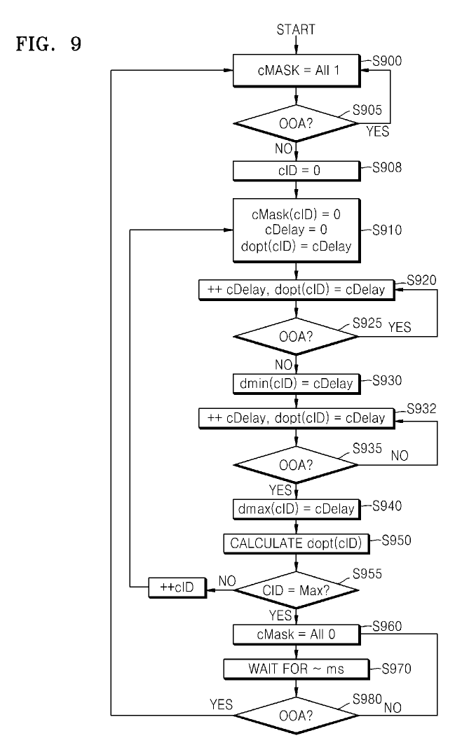

FIG. 9 is a flowchart illustrating the operation of the delay control unit 760 of the apparatus of FIG. 7 according to an embodiment of the present invention.

The fixed delay unit 730 delays a deskew signal by an appropriate delay. The delay is determined so that an OOA alarm is generated during initialization.

The amount of fixed delay may range from 0x20 to 0x30 in consideration of the operation of the gigabit transceivers 740.

When the select signals S(7:0) range from 0x20 to 0x30, several Gbps signals are delayed by approximately 32 to 48 clocks.

A start signal is applied when the FPGA is turned on.

In operation S900, all cMask signals, which are select signals of the selectors 750 of FIG. 7, are set to 1.

Once all the cMask signals are set to 1, each of signals output from the FPGA becomes a skew-free signal, such that an OOA alarm of the 16:1 high-speed serializer 770 becomes a normal signal.

Thereafter, only a first signal is selected from among the 16 signals as an output signal of the digital signal processing block 710, and a skew-free signal is applied to the other signals.

That is, in operation S910, cMask signals output from the delay control unit 760 are set so that cMask(0)=0, cMask(k)=1, and k=1˜15.

The dopt signals of the delay units 730 has cDelay values which show a delay amount, and the cDelay values are set to 0.

Since a deskew signal is delayed by tens of clocks, which exceeds a limit that the 16:1 high-speed serializer 770 allows, an OOA alarm is generated.

The OOA alarm becomes an OOA alarm with respect to the first signal.

This is because the skew-free signal is applied to the other signals than the first signal.

In operation S920, while the OOA alarm is generated, the cDelay values are increased one by one and an OOA state is continuously monitored.

The increasing of the cDelay values one by one means that input data signals of the delay units 730 are delayed by one clock at a speed of several Gbps signals.

As the cDelay values are increased, the corresponding data signal is delayed within the limit allowed by the 16:1 high-speed serializer 770, such that the OOA alarm is removed. In operation S930, a cDelay value at this time is stored as a minimum value dmin.

When the cDelay values are increased one by one again, the corresponding data signal is delayed beyond the limit allowed by the 16:1 high-speed serializer 770, and thus an OOA alarm is generated.

In operation S940, a cDelay value at this time is stored as a maximum value dmax.

In operation S950, an intermediate value between the minimum value dmin and the maximum value dmax is determined as a dopt value for the first signal.

Thereafter, cMask signals are set so that cMask(1)=0, cMask(k)=1, and k=0, 2˜15, and then the same process as described above is performed to obtain a dopt value for a second signal.

In operation S960, dopt values for all the 16 data signals are obtained, and then all the cMask signals are set to 0 so that an original data signal can be transmitted.

In operation S970, an OOA state is checked periodically. In operation S980, it is determined whether an alarm is generated, and when it is determined that the alarm is generated, dopt values for all the signals are obtained from the beginning again.

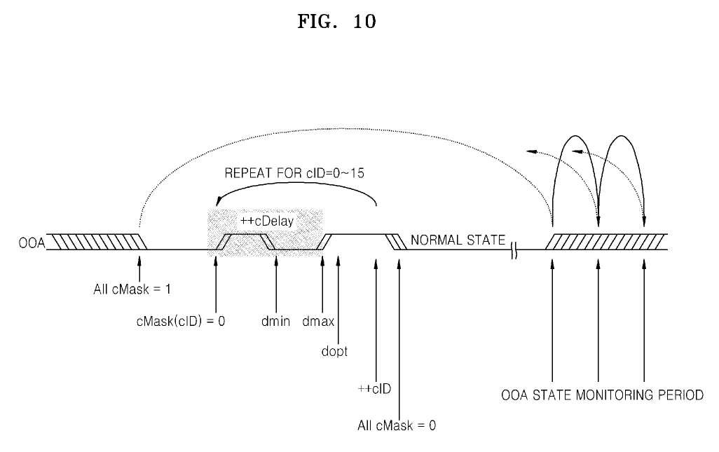

FIG. 10 illustrates the operation of the delay control unit 760 of the apparatus of FIG. 7 on a time axis, according to an embodiment of the present invention.

The delay control unit 760 initially sets all cMask signals to 1 and waits for a time when an OOA signal becomes a normal signal.

When the OOA signal becomes a normal signal, a minimum value dmin and a maximum value dmax at which the OOA signal becomes a normal signal are obtained from a first data signal and a dopt value, which is an intermediate value between the minimum value dmin and the maximum value dmax, is obtained.

The delay control unit 760 repeats the process of obtaining the dopt value on 16 signals.

After all dopt values are obtained, the cMask signals are set to 0.

Since all the signals are delayed within a limit allowed by the 16:1 high-speed serializer 770, an OOA state becomes a normal state.

The OOA state is monitored and then the above process is restarted or the current state is maintained.

The present invention may be embodied as computer-readable codes on a computer-readable recording medium. The computer-readable recording medium is any data storage device that can store data which can be thereafter read by a computer system.

Examples of the computer-readable recording medium include read-only memories (ROMs), random-access memories (RAMs), compact disc (CD)-ROMs, magnetic tapes, floppy disks, optical data storage devices, and carrier waves (such as data transmission through the Internet). The computer-readable recording medium can be dispersively installed in a computer system connected to a network, and stored and executed as a computer-readable code in a distributed computing environment.

As described above, the apparatus for and method of automatically controlling the skew between the transmitted data according to the present invention can be used to implement a system by using any of various manufacturers' FPGAs including gigabit transceivers, since any type of FPGA can be selected regardless of the manufacturer thereof.

Accordingly, the apparatus and method according to the present invention can increase cost competitiveness and reduce the price of the system.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An apparatus for automatically controlling skew between transmitted data, the apparatus comprising:
a high-speed serializer serializing a plurality of low-speed parallel data signals into high-speed data signals, outputting the high-speed data signals, and generating an out of alignment (OOA) alarm signal when skew between the low-speed parallel data signals which exceeds an allowable limit is generated;
a plurality of selectors including a skew-free signal that prevents the OOA alarm signal from being generated into signals other than at least one signal from among the low-speed parallel data signals;
a plurality of delay units delaying and outputting in units of bits the at least one low-speed data signal into which the skew-free signal is not included; and
a delay control unit controlling the selectors and the delay units on the basis of the OOA alarm signal of the high-speed serializer.

2. The apparatus of claim 1, wherein the selectors, the delays, and the delay control unit are implemented in a field-programmable gate array (FPGA).

3. The apparatus of claim 2, further comprising:
a deskew frame generator sampling some of internal signals, which are obtained by dividing the low-speed parallel data signals into several data signals, according to Serdes Framer Interface Level-5 (SFI-5) and generating a deskew signal which is a reference signal for obtaining the skew; and
gigabit transceivers serializing the internal signals and generating the low-speed parallel data signals.

4. The apparatus of claim 3, wherein the high-speed data signals have a transmission rate in the range of tens of Gbps, the low-speed data signals have a transmission rate in the range of several Gbps, and the internal signals have a transmission rate in the range of hundreds of Mbps.

5. The apparatus of claim 1, wherein the OOA alarm signal is a sum of OOA alarm signals with respect to the plurality of low-speed parallel data signals.

6. A method of automatically controlling skew between transmitted data, the method comprising:
including a skew-free signal, which prevents an OOA alarm signal from being generated when skew between a plurality of low-speed parallel data signals which exceeds an allowable limit is generated, into signals other than a first low-speed parallel data signal from among the low-speed parallel data signals;
delaying and outputting the first low-speed data signal in units of bits;
obtaining an optimal delay that prevents the OOA alarm signal from being generated by changing the delay of the first low-speed data signal;
repeating the including of the skew-free signal, the delaying and outputting of the first low-speed data signal, and the obtaining of the optimal delay on each of the other signals than the first low-speed parallel data signal from among the plurality of low-speed parallel data signals; and
serializing a plurality of low-speed parallel data signals which are output each by the obtained optimal delay value and outputting the serialized low-speed parallel data signals as high-speed data signals.

7. The method of claim 6, wherein the including of the free-skew signal, the delaying and outputting of the first low-speed data signal, and the obtaining of the optimal delay are performed in an FPGA.

8. The method of claim 6, wherein the OOA alarm signal is a sum of OOA alarm signals with respect to the plurality of low-speed parallel data signals.

9. The method of claim 6, further comprising:
sampling some of internal signals, which are obtained by dividing the low-speed parallel data signals into several data signals, according to SFI-5, and generating a deskew signal which is a reference signal for obtaining the skew; and
serializing the internal signals and generating the low-speed parallel data signals.

10. The method of claim 8, wherein, whenever the OOA alarm signal is generated, the including of the skew-free signal, the delaying and outputting of the first low-speed data signal, and the obtaining of the optimal delay are repeated.

11. The method of claim 9, wherein the high-speed data signals have transmission rate in the range of tens of Gbps, the low-speed data signals have transmission rate in the range of several Gbps, and the internal signals have transmission rate in the range of hundreds of Mbps.
